(19) United States
(12) Patent Application Publication
(10) Pub. No.: US 2024/0183366 A1
(43) Pub. Date: Jun. 6, 2024

(54) Multi-Port Flow Control Actuators for Flow Control

(71) Applicant: Ahmad D. Vakili, Thompsons Station, TN (US)

(72) Inventor: Ahmad D. Vakili, Thompsons Station, TN (US)

(21) Appl. No.: 18/386,079

(22) Filed: Nov. 1, 2023

Related U.S. Application Data
(60) Provisional application No. 63/475,393, filed on Nov. 7, 2022.

(51) Int. Cl. F15D 1/00

(52) U.S. Cl. CPC F15D 1/002

(57) ABSTRACT

A multi-port flow control actuator (MPFCA) for controlling a fluid flow across an aerodynamic surface includes a housing having an internal chamber and a first and second fluid passageway connected to the internal chamber. A first port is connected to the first fluid passageway and a second port is connected to the second fluid passageway. An oscillating membrane is positioned in the internal chamber that causes fluid to enter one of the first port and second port and exit one of the first port and second port when the oscillating membrane is oscillated. A fluid line may be provided for injecting a supply fluid such as a fuel or oxidizer into the internal chamber volume. The first and second port may be positioned along a line that is at an angle, parallel or perpendicular to a fluid flow to create different flow effects.

### CROSS-REFERENCES TO RELATED APPLICATIONS

The present application claims priority from co-pending U.S. Provisional Patent Application No. 63/475,393, filed Nov. 1, 2022, entitled “Multi-Port Flow Control Actuators” which is hereby incorporated by reference.

### FIELD OF THE INVENTION

The present invention is generally related to the field of flow control.

### BACKGROUND OF THE INVENTION

In advanced and high performance aerodynamic and fluid mechanical systems it can be quite difficult, and often practically impossible, to achieve optimum performance at varying and desired operational conditions without the use of flow control devices. Boundary layer flow control for maintaining laminar flow by delay of transition onset to turbulent flow, reducing adverse effects of shock boundary layer interactions, eliminating flow separation, elimination of flow unsteadiness in open cavities, managing heat transfer, and drag reduction are only a few of the flow phenomenon which frequently lead designers to use passive or active flow control devices to help improve a system's fluid dynamic performance.

Flow control devices, also known as flow control actuators, of various designs are frequently used at specific locations over or near aerodynamic surfaces to modify local flows, and possibly impact the overall flow effects. A large variety of passive and active flow control devices have been developed for various applications in fluid engineering and aerospace applications. A few examples of typical flow control applications' desired outcomes are to reduce or eliminate flow separation, reduce drag, reduce shock boundary layer effects, increase mixing, increase or manage heat transfer from, or to, a surface, and reduce or eliminate total pressure distortion at a jet engine inlet, if an engine inlet is located at the end of a serpentine inlet. Passive flow control devices, such as vortex generators, are positioned as stationary additions on a surface. Such flow control devices can change the near surface flow patterns to accomplish a desired effect like elimination of flow separation on a surface in limited flow conditions. Active flow control devices are generally powered devices which function in a control loop to minimize or eliminate a flow effect sensed by one or more local sensors. In certain applications, a wide range of effective flow control may be provided by active devices which are electrically powered, consuming minimal energy to accomplish desired results. A primary advantage of such devices is access for delivering power for such flow control devices only requires electrical wires, which are normally readily managed.

Earlier studies have shown that a jet of air may be produced from an orifice on one sidewall of a closed chamber, if one side wall of the chamber is replaced by a vibrating membrane, when it is excited at certain frequencies and amplitudes. However, such a device can have a limited control effectiveness and more effective and versatile flow control actuators are still needed.

### BRIEF SUMMARY OF THE INVENTION

An embodiment of the present invention is directed toward a multi-port flow control actuator with a minimum of two ports or orifices. The multi-port flow control actuator comprises a housing having an internal chamber. A first fluid passageway is connected to the internal chamber and a second fluid passageway is connected to the internal chamber. The first and second fluid passageways are interconnected internally using an intricate custom configuration. A first port is connected to the first fluid passageway and a second port is connected to the second fluid passageway. One of the chamber surfaces, typically opposite to the actuator's aerodynamic surface, is fitted with a flexible membrane which can be excited to provide periodic oscillatory motion. The oscillating membrane encloses the chamber volume and the first and second passageways are configured such that oscillation of the oscillating membrane causes fluid to enter one of the first port and second port and exit one of the first port and second port.

In some embodiments, at least one of the first port and the second port is positioned on an aerodynamic surface. The first port may further comprise a plurality of ports positioned in a pattern around the second port. The first port may be an inlet port that generates net suction and the second port an outlet port that generates net blowing.

In some embodiments, the multi-port flow control actuator further comprises a fluid line for injecting a supply fluid into the internal chamber volume. In some of these embodiments, the supply fluid is a fuel or oxidizer.

In some embodiments, the multi-port flow control actuator is positioned on an aerodynamic surface and the first and second port are positioned along a line that is at an angle with respect to an aerodynamic fluid flow across the aerodynamic surface. Alternatively, the multi-port flow control actuator may be positioned on an aerodynamic surface and the first and second port be positioned along a line that is parallel or perpendicular to an aerodynamic fluid flow across the aerodynamic surface.

In some embodiments, the multi-port flow control actuator further comprises an aerodynamic surface and at least one of the first and second port are positioned such that a port opening of the at least one port is at an angle with respect to an aerodynamic fluid flow across the aerodynamic surface. In other embodiments, the multi-port flow control actuator further comprises an aerodynamic surface and the first and second port are positioned on the surface of the aerodynamic surface such that a port opening of at least one port is perpendicular to an aerodynamic fluid flow across the aerodynamic surface and a port opening of the other port is parallel to an aerodynamic fluid flow across the aerodynamic surface.

Another embodiment of the present invention is directed toward a multi-port flow control actuator that includes a housing having an internal chamber. A first fluid passageway is connected to the internal chamber. A plurality of second fluid passageways are also connected to the internal chamber. A first port is connected to the first fluid passageway. A plurality of second ports is each connected to at least one of the plurality of second fluid passageways. The plurality of second ports are positioned around the first port. One of the chamber surfaces, typically opposite to the actuator's aerodynamic surface is fitted with a flexible membrane. The membrane can be powered into periodic oscillatory motion which causes fluid to periodically enter one of the first port and the plurality of second ports and exit one of the first port and plurality of the second ports, with net inflows and outflows.

In some embodiments, the first port and the plurality of second ports are positioned on an aerodynamic surface exposed to a fluid flow across the aerodynamic surface. The first port may be an inlet port that generates net suction and the plurality of second ports outlet ports that generate net blowing. A fluid line may be included for injecting a supply fluid that may be fuel or an oxidizer into the internal chamber volume. At least one of the first and plurality of second ports may be positioned on an aerodynamic surface such that a port opening of at least one of the first and plurality of second ports is at an angle with respect to an aerodynamic fluid flow across the aerodynamic surface.

Yet another embodiment of the present invention is directed toward A multi-port flow control actuator that includes a housing having an internal chamber. The housing has an aerodynamic surface having a fluid flow across the aerodynamic surface. An inlet port and an outlet port are positioned on the aerodynamic surface. A first fluid passageway connects the inlet port to the internal chamber and a second fluid passageway connects the outlet port to the internal chamber. An oscillating membrane is positioned to enclose the internal chamber that generates net suction at the inlet port and net blowing at the outlet port when the oscillating membrane is oscillated. A fluid passage may be provided for injecting a supply fluid into the internal chamber. The inlet and outlet port may be positioned on the aerodynamic surface along a line that is at an angle, parallel or perpendicular to the fluid flow across the aerodynamic surface.

### BRIEF DESCRIPTION OF THE SEVERAL VIEWS OF THE DRAWINGS

FIG. 1 is an illustration of a multi-port flow control actuator in accordance with an embodiment of the present invention;

FIGS. 2(A) and (B) are illustrations of the oscillation of the membrane of the multi-port flow control actuator of FIG. 1 in accordance with an embodiment of the present invention;

FIGS. 3 (A-C) are illustrations of multi-port flow control actuators having shaped port inlets and outlets in accordance with various embodiments of the present invention;

FIGS. 4(A) and (B) are illustrations of a multi-port flow control actuator having a family of actuators in accordance with various embodiments of the present invention;

FIG. 5 is an illustration of a multi-port flow control actuator positioned on an aerodynamic surface in accordance with various embodiments of the present invention;

FIG. 6 is an illustration of exemplary processing circuitry for implementing an embodiment of the present invention; and

FIG. 7 is an illustration of the aerodynamic effects of an exemplary embodiment of the present invention.

### DETAILED DESCRIPTION OF THE INVENTION

As set forth herein, a new class of Multi-Port Flow Control Actuators (MPFCA), powered primarily by electricity, has been invented and functionally demonstrated by the present inventor. Various embodiments of the new MPFCA actuators have inflow (suction) ports and outflow (blowing) ports positioned on an aerodynamic surface having a fluid flow across the surface. Several variations of the multi-port flow control actuators have been designed, manufactured, instrumented, and tested to demonstrate the actuators' functionality for flow-control and heat transfer-control applications.

A basic embodiment of an MPFCA actuator may have just two ports on its aerodynamic control surface, which is the surface exposed to the external main fluid flow, nominally one inlet port and one outlet port. However, MPFCAs may be designed with one or more inlet port(s) and one or more outlet port(s), and are ideally custom designed for a particular flow control purpose as described in more detail herein. The MPFCAs are uniquely designed and configured to simultaneously generate net inflow (suction) and net outflow (blowing) from its their port(s) and outlet port(s), respectively. The described MPFCAs have a wide range of passive, adaptive, or active uses for flow control applications.

Embodiments of the MPFCA actuators are fundamentally designed to function as net zero mass flow control actuator devices. Low momentum fluid, such as air, water, etc., is periodically ingested via their inflow ports by oscillation of an oscillating membrane. The oscillating membrane generates pressure pulses that increase the ingested fluid's momentum and channel it so that it is ejected from the outflow port(s). Various embodiments of the MPFCA may further utilize a supply fluid that is introduced into the MPFCA's chamber volume, from an inlet or port other than its inlet(s) and outlet(s) flow control ports, for unique flow control purposes, such as enhanced mixing and combustion control.

In general, MPFCA actuators are custom designed three-dimensional enclosure configurations, having an open internal chamber volume with highly engineered contoured internal boundaries leading to at least two or more surface ports, one or more inlet ports and one or more outlet ports. The ports may be positioned on an the MPFCA's aerodynamic surface which is exposed to an external fluid flow. The MPFCA aerodynamic surface may replace an existing portion of the external flow surface when it is in use. The oscillating membrane may be integrated in the opposite face of the MPFCA aerodynamic surface to enable powered oscillatory motion.

Internal MPFCA design configurations for the chamber volume include flow passages from each port to one or more internal flow passages, designed to help generate inflow (suction) and outflow (blowing) streams from their corresponding ports. The actuator's ports are internally interconnected via carefully designed integral passages to enable a port to selectively function as an inlet port or as an outlet port with the actuation of the oscillating membrane. External actuator housing and internal chamber geometries, the number of ports, and the function of each of the actuator's ports may be custom configured depending on the MPFCA application's requirements. Further, groups of ports may be designed to function as suction ports integrated with one or more blowing port(s) to facilitate management of specific flow control and or heat transfer control objectives.

A MPFCA membrane may be electrically powered to oscillate, but may also be driven to oscillate by other means, to create changes in its internal chamber volume. In some embodiments, this is accomplished by periodic oscillation of a membrane fitted as one of its walls, typically the wall opposite to the aerodynamic surface with the suction and blowing ports. Some embodiments may be configured to be driven by oscillatory motions of more than one side wall membrane. The oscillatory volume change can be accomplished by replacing a wall with an electromechanical membrane, such as a piezo ceramic disk or an audio speaker, that creates periodic displacements. Depending on the size and geometry of an MPFCA, its peak performance for generating suction and blowing may be accomplished at a limited range of designed frequencies, which are herein referred to as the MPFCA chamber's natural acoustic frequency. However, an MPFCA can generate a tangible amount of suction and blowing within a much larger range of its membrane's oscillation frequencies, depending on its design details.

Each MPFCA may be installed in a manner to help modify the near surface flow in its proximity, by entraining, energizing, and reinjecting the flow into the main flow stream to generate specific desired flow patterns. Low momentum fluid from the suction port is entrained into its main chamber due to the suction pulses generated by the membrane and is discharged from the blowing port with increased momentum due to the periodic pressure pulses introduced by the motion of the membrane. Suction and blowing ports can be integrated in desired directions with respect to the external flow, such as tangential, vertical, or at intermediate angles. This provides flexibility in the flow control momentum and vorticity introduced into the external flow.

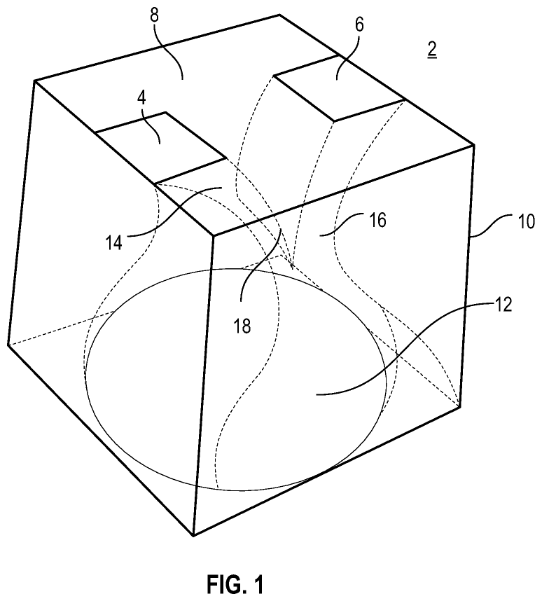

Referring now to FIG. 1, an illustration of a multi-port flow control actuator 2 in accordance with an embodiment of the present invention is shown. The MPFCA 2 includes an inlet port 4 and an outlet port 6 positioned on an aerodynamic surface 8 of a housing 10. The inlet port 4 and outlet port 6 are connected to an internal chamber volume 12 of the housing 10 via respective inlet 14 and outlet 16 passages. In the embodiment of FIG. 1, the ports 4 and 6 have rectangular openings. However, the ports may have circular or rectangular cross sections, transitioning to larger or smaller circular or rectangular internal passage ducts. An oscillating membrane 18 is positioned in the internal chamber volume 12.

The inlet 4 and outlet 6 ports and their internal passages' 14 and 16 geometries may be designed to be body conforming rectangular/elliptical shapes, or as best suited for any given application. The internal passages 14 and 16 detail design profile geometries help the MPFCA 2 to generate inflow (suction) and outflow (blowing) streams from their corresponding ports 4 and 6. The internal passages 14 and 16 are configured as integral passages to enable a port to function as an inlet port 4 or as an outlet port 6 by design.

Any suction port 4 shape may be tailored for the optimum local and global desired flow control effects. A suction port internal passage 14 may be designed to be connected to the blowing port's internal passage 16 at its profile minimum area location. The ideal location is determined to be the smallest area of the blowing passage 16. At this position in the internal passage 16 of the blowing port 6, there is a lower pressure present during the suction or pressure pulse generated by the motion of the oscillating membrane 18.

A blowing port passage 16 is internally configured to have smooth internal walls, typically gradually conforming its exit to a minimum area region and merging seamlessly with the chamber volume 12 there. The internal profile of each blowing port passage 16 is designed to smoothly connect with the internal passages of suction ports 4, as described and shown herein. Blowing port(s) 6 internal passage(s) 16 are designed to be the primary passage(s) connecting the blowing port(s) to the free internal volume 12 of the actuator 2. Each passage profile incorporates a strategically located minimum area (Vena Contracta) with a designed profile at a location where it is linked with the suction port passage 14. This is normally the position, in the internal passage of the blowing port, with the highest fluid velocity corresponding to the lowest pressure, generated by the motion of the oscillating membrane 18 during both the suction and pressure pulse cycles. This arrangement results in the suction port 4 supplying some fluid to the blowing port 6 during both half cycles of a complete oscillating membrane's 18 cycle. Hence, the actuator's 2 internal design allows customization of each port's 4 and 6 flow. At each blowing port exit 6, depending on its geometry, there is both peripheral suction and central blowing from different regions of the exit port 6. However, there is a net mass increase, via the suction port 4, and momentum increase, due to the membrane's 18 net pumping actions, forcing the outflow to form vortices which move into the local external flow at a higher relative speed. Any blowing port 6 exit shape may be tailored for optimum local and global desired flow control effects.

The oscillating membrane 18 may be configured to oscillate by certain pneumatic, acoustic, mechanical, electro-mechanical or piezoelectric effects. As the membrane 18 deforms, the internal chamber volume 12 of the actuator 2 changes. The free volume between the membrane 18 and blowing ports' entrance is defined as the chamber volume 12. Its volume increases or decreases as the oscillating membrane 18 moves outwards or inwards, respectively. The periodic changes in the volume of its chamber 12 are accompanied by positive and negative pressure pulses that travel at the speed of sound and result in near instantaneous suction and or blowing flow pulses at the ports' 4 and 6 exits.

In some embodiments, such moving pressure pulses may be generated by periodic electrical arcs (plasma) inside the chamber volume 12 of the actuator housing 10, without the need for a flexible membrane 18. Net suction flow and net blowing flow at each given port 4 and 6 is again accomplished by carefully designed internal passage profiles connecting and integrating the ports 4 and 6 with the chamber volume 12 of the actuator housing 10.

The internal chamber volume 12 and membrane 18 are configured such that oscillation of the membrane 18 causes fluid to be sucked into inlet port 4 and blown out of outlet port 6. Various types of membranes 18 similar but not limited to an electromechanical surface such as an audio speaker membrane driven at chamber natural/optimum frequencies, a magnetically driven metallic membrane driven at chamber natural/optimum frequencies, or a piezoelectric disk or membrane generating oscillatory displacements may be utilized in the internal chamber volume 12. A spark generated energy addition to the chamber may also be used to drive the oscillation.

The oscillatory motion of membrane 18 results in periodic internal chamber volume 12 changes resulting in positive and negative pressure pulses moving inside of the actuator 2. The periodic pressure pulses travel throughout the actuator chamber 12 with the speed of sound and generate oscillatory fluid motion thru the internal passages 14 and 16 and into and out of the various surface ports 4 and 6. The intricate configuration of internal chamber volume 12 is designed to facilitate net outflow and net inflow from the correspondingly designed ports 4 and 6.

Actuator housing 10 external and internal chamber volume 12 geometries, number of ports 4 and 6, and the function and location of each of the actuator's ports may be custom designed and configured, depending on aerodynamic surface geometries and desired type of flow control and/or thermal control applications.

In various embodiments, a MPFCA may be driven and/or powered by one of several different methods. For example, a MPFCA may utilize an oscillatory motion caused by an oscillating membrane fitted into its surface boundary other than the aerodynamic surface. In other embodiments, a periodic energy release, such as a periodic high voltage electrically generated spark between two or more electrodes within its enclosure volume may be utilized. An external energy source may be used to generate the sparks or cause the membrane to oscillate around its stationary position. In yet other embodiments, a supplementary flow of fuel with or without oxidizer may be used to complement either of the above described methods and generate periodic combustion for advanced combustion flow control.

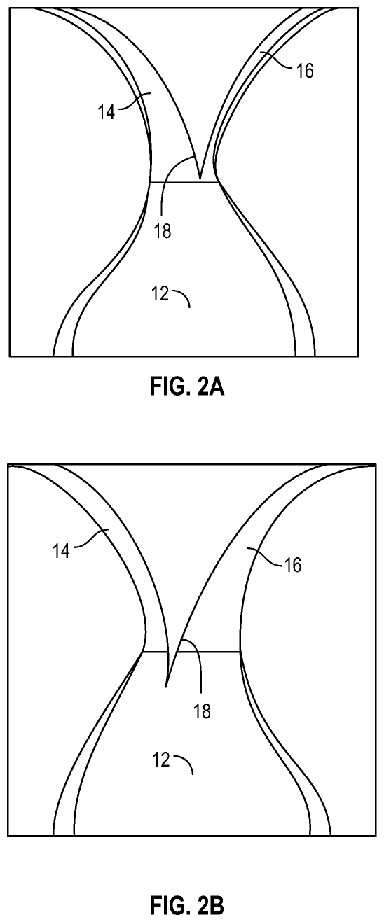

FIGS. 2(a) and (b) are illustrations of the oscillation of the membrane 18 of the multi-port flow control actuator 2 of FIG. 1 in accordance with an embodiment of the present invention. Due to the geometry of the internal volume 12, inlet passage 14, outlet passage 16 and oscillating membrane 18, when oscillating membrane 18 oscillates from its central position to the right as shown in FIG. 2(A), fluid is drawn through inlet passage 14 into internal volume 12 and expelled from outlet passage 16 through outlet port 6. When oscillating membrane 18 oscillates from its central position to the left as shown in FIG. 2(B), fluid is forced from inlet passage 14 into internal volume 12 and from internal volume 12 into outlet passage 16.

In some embodiments, the MPFCA 2 may be customized for multifluid mixing for improved chemical reactions or combustion control and may additionally have a specific fluid as an input supplied to accommodate the desired purpose. Further, in desired embodiments, periodic thermal energy addition internal to the MPFCA housing 10 at designed locations can also power the MPFCA 2 functions. In certain embodiments, e.g., combustion flow control applications, a nominal amount of fluid flow, which may be fuel or fuel rich fluid, may be supplied to the internal chamber volume 12 for the purposes of increasing mixing and flow penetration for more efficient combustion. Such actuators may be referred to as Aspirating Multi-Port Flow Actuators.

Various MPFCA embodiments may also have different numbers and arrangements of their aerodynamic surface ports, where internal ducting and exposed ports are engineered for custom external flow control applications. The number of ports and their interconnecting ducts are design features fitting the class of MPFCAs. As discussed herein, each of the various flow control surface ports are designed to generate either net suction, as inflow port(s), and or generate net blowing, as outflow port(s). The aerodynamic surface ports are strategically positioned for effective control purposes on the MPFCA aerodynamic surface. For example, one or more of the MPFCA enclosure surfaces, typically opposite to its aerodynamic surface having with the suction and blowing ports, may be fitted with a flexible membrane which can be excited to provide periodic oscillatory motion.

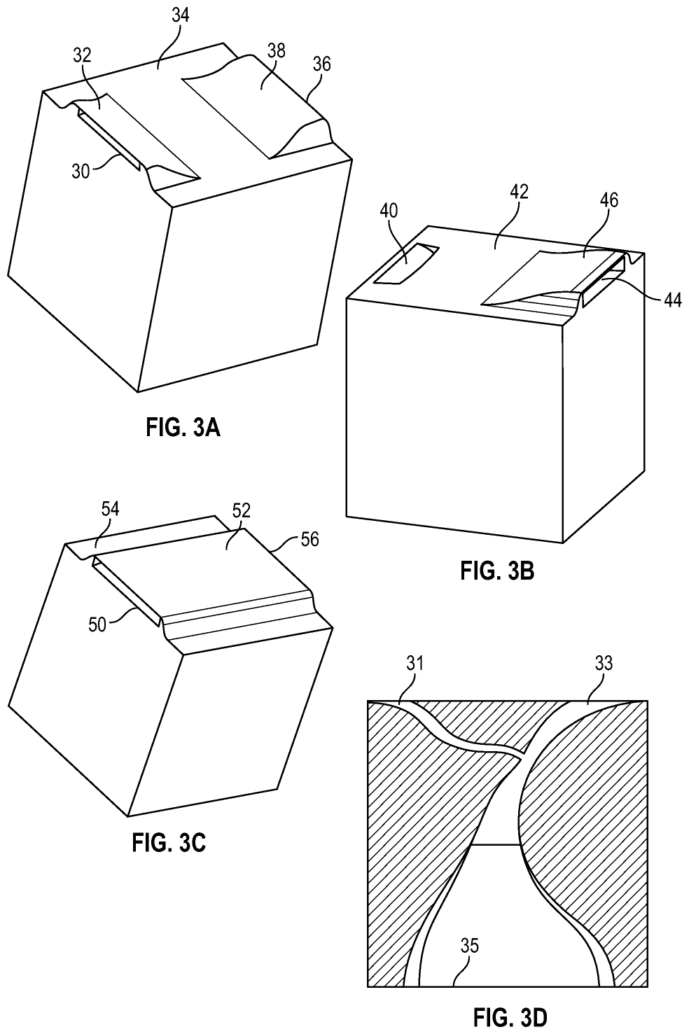

FIGS. 3 (A-C) are illustrations of multi-port flow control actuators having shaped port inlets and outlets in accordance with various embodiments of the present invention. In FIG. 3(A), the inlet port 30 is positioned on an upstream face on a raised portion 32 of the aerodynamic surface 34 and the outlet port 36 is positioned on an downstream face of a raised portion 38 of the aerodynamic surface 34. The positioning of the ports 30 and 36 shown in FIG. 3(A) further facilitates the flow into and out of the ports 30 and 36. An MPFCA design with two ports, such as shown in FIG. 3(A), with selected azimuthal angles with the aerodynamic flow surface and its normal plane, such as 90 degrees to the flow surface, may function as 3D vortex generators.

In FIG. 3(B), the inlet port 40 is positioned level with the aerodynamic surface 42 and the outlet port 44 is positioned on an downstream face of a raised portion 46 of the aerodynamic surface 42 such that the opening of the outlet port is perpendicular to the fluid flow. The positioning of the ports 40 and 44 shown in FIG. 3(B) may be desirable when surface turbulence needs to be minimized on the aerodynamic surface 42 near the inlet port 40.

In FIG. 3(C), the inlet port 50 is positioned on an upstream face on a raised portion 52 of the aerodynamic surface 54 perpendicular to the fluid flow and the outlet port 56 is positioned on an downstream face of the raised portion 52 of the aerodynamic surface 54 perpendicular to the fluid flow. The positioning of the ports 50 and 56 shown in FIG. 3(C) helps reduce surface turbulence between the ports 50 and 56 with respect to the embodiment of FIG. 3(A).

The MPFCA as a multifunctional flow control actuator can be categorically designed and configured in many geometric configurations including, but not limited to, MPFCA-2D configurations (MPFCA-2D); MPFCA Axi-Symmetric configurations (MPFCA-AxS) and aspirating MPFCA configurations.

MPFCA-2D configurations are designed for the purposes of facilitating flow separation control or flow mixing enhancement by removing low kinetic energy flow and imparting momentum into the blowing flow in desired directions and forcing various types of symmetric or asymmetric vortices formations. The inlet/exit port shapes and the suction and blowing flow port and their relative orientation to the local flow direction will determine the types of vortices formed. A MPFCA-2D configuration will have two or more inlet/exit ports, which are individually designed and integrated with internal passage configurations to function as optimum suction and blowing ports. An embodiment of a MPFCA-2D configuration may have two or more inlet/outlet ports with internal passages which maybe 2D-symmetric and therefore, each port will function as both suction and blowing ports.

MPFCA-AxS configurations are comprised of two or more inlet-ports and a central exit port which are symmetrically configured where the central exit port is installed normal to the aerodynamic surface. Such a configuration will have typically several (two or more) inlet ports with one exit port, which are individually designed and integrated with internal passage configurations to function as suction and blowing ports. MPFCA-AxS configurations are primarily utilized for the purposes of facilitating flow surface heat transfer, flow mixing, flow aspiration-enhancement and flow control by removing low kinetic energy fluid near a surface, imparting momentum into the blowing flow and forcing various types of vortex ring formation which facilitate energy transport away from the surface.

The inlet/exit port shapes and the local flow properties determine the types of vortices formed. For example, an MPFCA may be configured with an even number of ports, parallel or perpendicular to the main flow that function as vortex pair generators for flow control. Accordingly, an MPFCA embodiment with an even number of ports, positioned perpendicular to the main flow direction, may be configured to function as a symmetric horseshoe vortex generator and an MPFCA embodiment with two ports, positioned parallel to the main flow may be configured to function as a streamwise vortex generator. An MPFCA embodiment with several ports for normal pulsed jets may be configured to be a vortex ring generator.

Aspirating MPFCA embodiments may be used to facilitate supplementary injection of fluid for combustion and mixing flow control. Any of the above discussed configurations may be modified to additionally include a nominal fluid supply line into the actuator chamber volume and be an aspirating MPFCA. Such fluid may be a cooling fluid or a fuel for customized mixing purposes with the external flow, such as fuel and or a mixture of fuel and oxidizers to support flame holding and mixing in the region of injection in a cross flow.

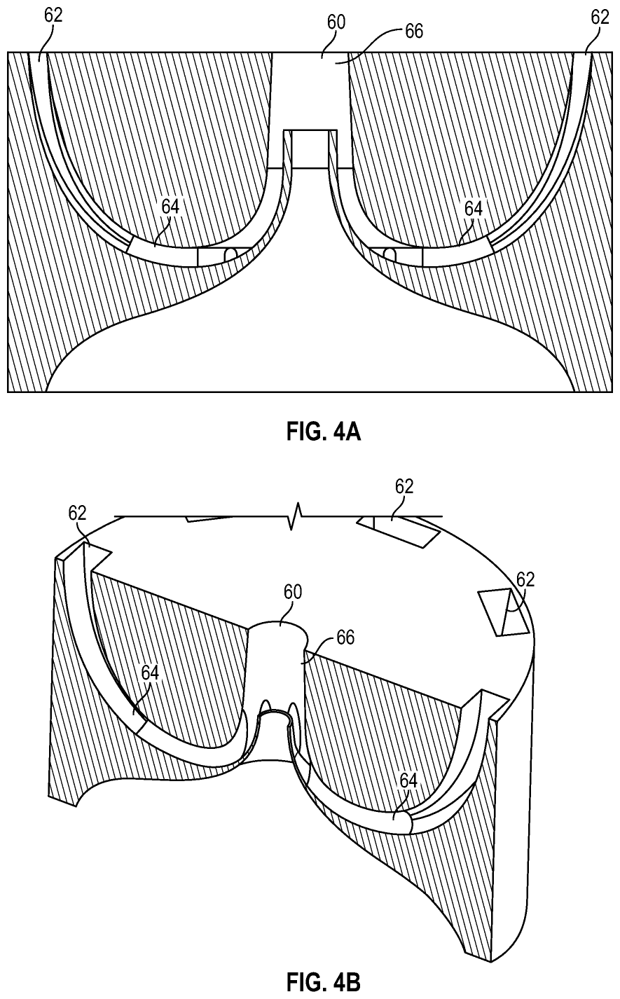

In some embodiments, groups of ports may be designed to internally connect to a main plenum and port to facilitate both suction and blowing flow control functions and or heat transfer enhancement and thermal management. FIGS. 4(A) and (B) are illustrations of a multi-port flow control actuator having a family of actuators in accordance with another embodiment of the present invention. As shown in FIGS. 4(A) and (B), the MPFCA includes a central exit nozzle 60 surrounded by a series of peripheral inlet ports 62. All of the inlet ports 62 are ducted through passages 64 to a plenum 66 so that central exit nozzle 60 is free and open at is exit which induces fluid to flow uniformly from all of the inlet ports 62 with minimal resistance.

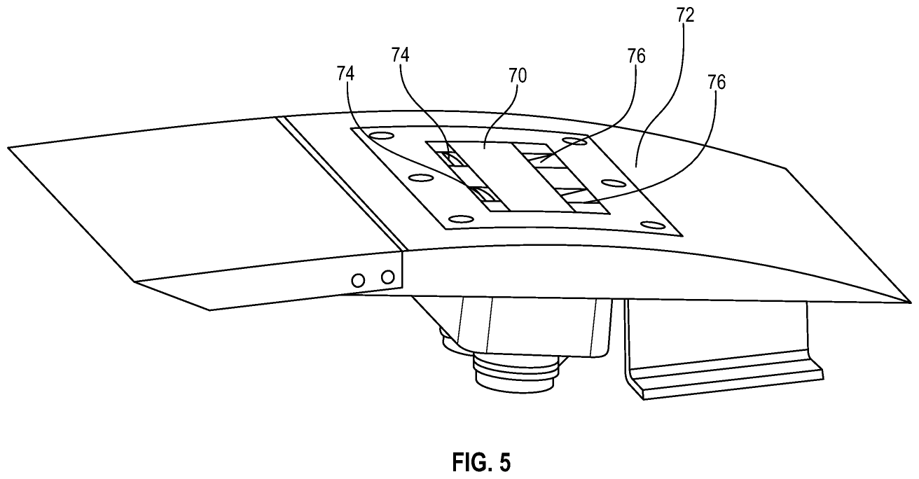

FIG. 5 is an illustration of a multi-port flow control actuator 70 positioned on an aerodynamic surface 72 in accordance with another embodiment of the present invention. The MPFCA 70 includes two flush configured inlet ports 74 positioned on the aerodynamic surface 72 upstream of two flush configured outlet ports 76 positioned on the aerodynamic surface 72. The inlet ports 74 and outlet ports 76 are connected to an internal volume with an oscillating member via respective inlet and outlet passages as described herein. The embodiment of FIG. 5 illustrates the ease with which embodiments of the present invention can be incorporated into existing aerodynamic structures such as a wing.

As discussed above, an MPFCA integrates intricate internal flow passages interconnecting the ports that are designed to direct the net inflow (suction) port(s) flow to the net outflow (blowing) port(s) stream from their corresponding ports, while a membrane 18 is powered to oscillate by a controller signal. The MPFCA controller output frequency and amplitude may be predetermined or varied for active flow control with input from a local sensor, typically located on the aerodynamic surface flow being controlled. Multiple MPFCA actuators may be configured as a group to accomplish desired flow control functions. Alternately, custom MPFCA actuators made by combining the features of individual MPFCA actuators may be implemented to ensure integrated performance and robustness. A typical MPFCA is connected to electrical power and is otherwise fully isolated with no need for an input flow.

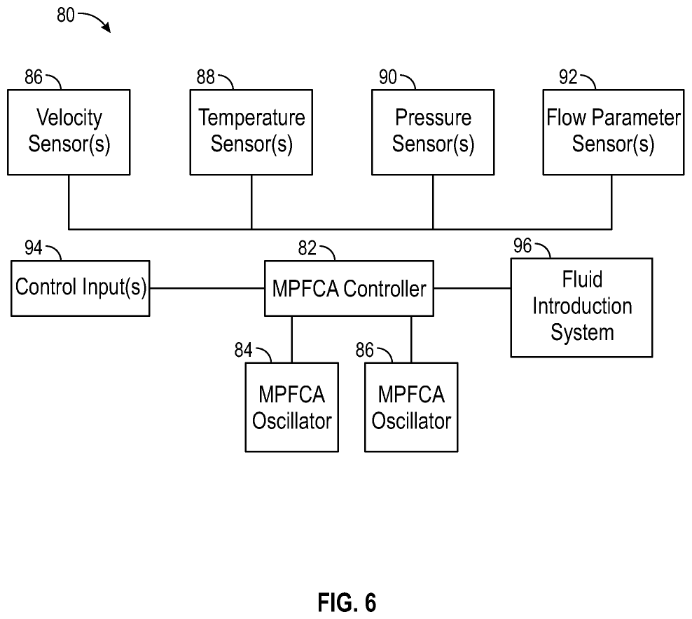

FIG. 6 is an illustration of exemplary processing circuitry 80 for a multi-port flow control actuator in accordance with an embodiment of the present invention. The processing circuitry includes a MPFCA controller 82 that is connected to one or more oscillators 84 and 86 that can be used to drive oscillating membranes as described herein. The MPFCA controller 82 receives inputs from one or more sensors such as velocity sensor(s) 86, temperature sensor(s) 88, pressure sensor(s) 90 and flow parameter sensor(s) 92. The MPFCA controller 82 may also receive one or more control input(s) 94. The control inputs 94 may reflect signals from an operator or control system of a device such as an aircraft that indicate a desired effect from one or more MPFCAs that the MPFCA controller 82 converts in control signals for the MPFCA oscillators 84 and 86. In some embodiments, the MPFCA controller 82 may be connected to a fluid introduction system 96 that is used to selectively introduce fluid into the internal chamber volume or passageways of the MPFCA as described herein. The feedback control system in the MPFCA controller 82 can have the capability to use frequency, amplitude and phase as control variables for maximum effectiveness. The control process is preferably customized for each application category of flows to be controlled, and is able to fine tune its response as the flow varies.

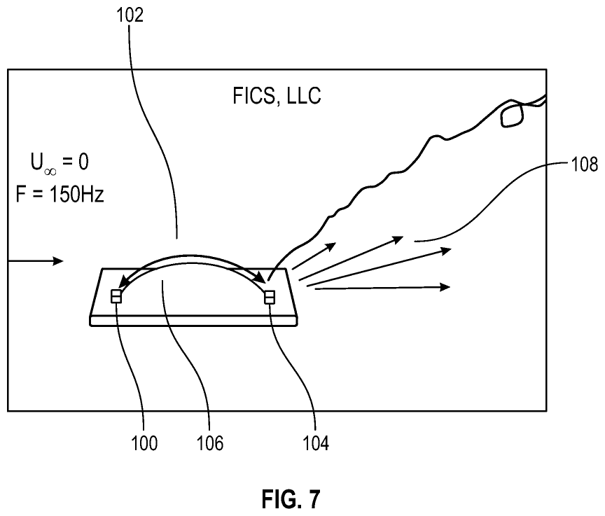

Operation of MPFCA's for effectiveness purposes in foundational flow control applications have been demonstrated from physical models and test configurations. FIG. 7 is an illustration of the aerodynamic effects of an exemplary embodiment of the present invention. The MPFCA of FIG. 7 includes a flush configured inlet port 100 positioned on the aerodynamic surface 102 upstream of a flush configured outlet port 104 positioned on the aerodynamic surface 102. The inlet port 100 and outlet port 104 are connected to an internal volume with an oscillating member via respective inlet and outlet passages (not shown in FIG. 7 but as described herein). A fluid flow is flowing from left to right across the aerodynamic surface 102. The sucking of fluid into the inlet port 100 results in a minimal amount of downstream turbulence 106 along the aerodynamic surface 102. Conversely, the blowing of fluid out of outlet port 104 results in a relatively large amount of downstream turbulence 108 along the aerodynamic surface 102. Thus, by selectively positioning the inlet port 100 and outlet port 104 in the desired positions, the desired aerodynamic effects can be achieved.

There are many different flow parameters and/or objectives that may be considered when positioning and operating an MPFCA. These include flow separation control; shock boundary layer interactions control; boundary layer flow profile management; boundary layer flow transition control; generating streamwise vortices for flow mixing enhancement; engine inlet flow management; serpentine duct swirl flow and distortion control; wall heat transfer control, boundary layer flow thermal profile management and combustion and mixing flow control.

Depending on each ports' internal passage arrangements, corresponding to the ports designed function, an actuator can also be configured to impart certain net kinetic energy (momentum) into the external flow in a desired direction, at its blowing port(s)′ location. The increase in flow kinetic energy which is generated by the actuator can be directed for effectively interacting with nearby flow features to accomplish desired flow control goals. Effective flow control, enabled by implementing this technology, influences the local and global flow field towards achieving desired net flow control effects, which are otherwise not readily possible.

Although there have been described particular embodiments of the present invention of new and useful Multi-Port Flow Control Actuators for Flow Control, it is not intended that such references be construed as limitations upon the scope of this invention except as set forth in the following claims.

What is claimed is:

1. A multi-port flow control actuator, said multi-port flow control actuator comprising:
a housing having an internal chamber;
a first fluid passageway connected to the internal chamber;
a second fluid passageway connected to the internal chamber;
a first port connected to the first fluid passageway;
a second port connected to the second fluid passageway; and
an oscillating membrane in the internal chamber and the first and second passageways configured such that oscillation of the oscillating membrane causes fluid to enter one of the first port and second port and exit one of the first port and second port.

2. The multi-port flow control actuator of claim 1 wherein at least one of the first port and the second port is positioned on an aerodynamic surface.

3. The multi-port flow control actuator of claim 1 wherein the first port is an inlet port that generates net suction and the second port is an outlet port that generates net blowing.

4. The multi-port flow control actuator of claim 1 further comprising a fluid line for injecting a supply fluid into the internal chamber volume.

5. The multi-port flow control actuator of claim 4 wherein the supply fluid is a fuel or oxidizer.

6. The multi-port flow control actuator of claim 1 wherein the first port further comprises a plurality of ports positioned around the second port.

7. The multi-port flow control actuator of claim 1 wherein the multi-port flow control actuator is positioned on an aerodynamic surface and the first and second port are positioned along a line that is one of parallel and perpendicular to a fluid flow across the aerodynamic surface.

8. The multi-port flow control actuator of claim 1 wherein the multi-port flow control actuator is positioned on an aerodynamic surface and the first and second port are positioned along a line that is at an angle with respect to a fluid flow across the aerodynamic surface.

9. The multi-port flow control actuator of claim 1 wherein the multi-port flow control actuator further comprises an aerodynamic surface and at least one of the first and second port are positioned such that a port opening of the at least one port at an angle with respect to a fluid flow across the aerodynamic surface.

10. The multi-port flow control actuator of claim 1 wherein the multi-port flow control actuator further comprises an aerodynamic surface and the first and second port are positioned on the surface of the aerodynamic surface such that a port opening of at least one port is perpendicular to a fluid flow across the aerodynamic surface and a port opening of the other port is parallel to a fluid flow across the aerodynamic surface.

11. A multi-port flow control actuator, said multi-port flow control actuator comprising:
a housing having an internal chamber;
a first fluid passageway connected to the internal chamber;
a plurality of second fluid passageways connected to the internal chamber;
a first port connected to the first fluid passageway;
a plurality of second ports, each of the plurality of second ports connected to at least one of the plurality of second fluid passageways, the plurality of second ports positioned around the first port; and
an oscillating membrane in the internal chamber and the first and second plurality of fluid passageways configured such that oscillation of the membrane causes fluid to enter one of the first port and the plurality of second ports and exit one of the first port and plurality of second ports.

12. The multi-port flow control actuator of claim 11 wherein the first port and the plurality of second ports are positioned on an aerodynamic surface exposed to a fluid flow across the aerodynamic surface.

13. The multi-port flow control actuator of claim 11 wherein the first port is an inlet port that generates net suction and the plurality of second ports are outlet ports that generate net blowing.

14. The multi-port flow control actuator of claim 11 further comprising a fluid line for injecting a supply fluid into the internal chamber volume.

15. The multi-port flow control actuator of claim 14 wherein the supply fluid is a fuel or oxidizer.

16. The multi-port flow control actuator of claim 11 wherein at least one of the first and plurality of second ports is positioned on an aerodynamic surface such that a port opening of at least one of the first and plurality of second ports is at an angle with respect to a fluid flow across the aerodynamic surface.

17. A multi-port flow control actuator, said multi-port flow control actuator comprising:
a housing having an internal chamber, the housing having an aerodynamic surface having a fluid flow across the aerodynamic surface;
an inlet port positioned on the aerodynamic surface;
an outlet port positioned on the aerodynamic surface;
a first fluid passageway, the first fluid passageway connecting the inlet port to the internal chamber;
a second fluid passageway, the second fluid passageway connecting the outlet port to the internal chamber; and
an oscillating membrane positioned in the internal chamber that generates net suction at the inlet port and net blowing at the outlet port when the oscillating membrane is oscillated.

18. The multi-port flow control actuator of claim 1 further comprising a fluid passage for injecting a supply fluid into the internal chamber.

19. The multi-port flow control actuator of claim 1 wherein the inlet and outlet port are positioned on the aerodynamic surface along a line that is at an angle with respect to a fluid flow across the aerodynamic surface.

20. The multi-port flow control actuator of claim 1 wherein the multi-port flow control actuator further comprises an aerodynamic surface and at least one of the first and second port are positioned on the surface of the aerodynamic surface such that a port opening of the at least one port is at an angle with respect to a fluid flow across the aerodynamic surface.
